(19) United States
(12) Patent Application Publication
(10) Pub. No.: US 2005/0144068 A1
(43) Pub. Date: Jun. 30, 2005

(54) Secondary market for keyword advertising

(75) Inventors: Hermann Calabria, Los Altos, CA (US); Francine R. Chen, Menlo Park, CA (US); Ayman O. Farahat, San Francisco, CA (US); Daniel H. Greene, Sunnyvale, CA (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: PALO ALTO RESEARCH CENTER INCORPORATED

(21) Appl. No.: 10/742,667

(22) Filed: Dec. 19, 2003

(51) Int. Cl. G06F 17/60

(52) U.S. Cl. 705/14

(57) ABSTRACT

A method of trading a future right to a keyword advertisement placement associated with a search results list, wherein the search results list is generated in response to a search query. The method includes creating ownership of the future right to the keyword advertisement placement in an original keyword search engine. Next, the future right to the keyword advertisement placement originally owned by the original keyword search engine is made available for purchase in a keyword advertising market. Then, the future right to the keyword advertisement placement originally owned by the original keyword search engine is traded to another participant in the keyword advertising market.

### BACKGROUND

The present exemplary embodiment relates to a secondary market for keyword advertising placements associated with or found within a regular search results list generated, for example, by an Internet search engine in response to a keyword query submitted by a user. It finds particular application in conjunction with selling, buying, and trading in future rights to placements of keyword advertisements associated with or found within the regular search results list, and will be described with particular reference thereto. However, it is to be appreciated that the present exemplary embodiment is also amenable to other like applications.

An increasingly popular way of delivering Internet advertisements is to tie the advertisement to search query results. In order to target advertising accurately, advertisers or vendors pay to have their advertisements presented in response to certain kinds of queries—that is, their advertisements are presented when particular keyword combinations are supplied by the user of the search engine.

For example, when a user searches for “deck plans,” using a search engine such as Google or AltaVista, in addition to the usual query results, the user will also be shown a number of sponsored results. These will be paid advertisements for businesses, generally offering related goods and/or services. In this example, the advertisements may therefore be directed to such things as deck plans, lumber, wood sealers, or even design automation software. Of course, the advertisements may be directed to apparently less seemingly related subject matter. While the presentation varies somewhat between search engines, these sponsored results are usually shown a few lines above, or on the right hand margin of the regular results. Although, the sponsored results may also be placed anywhere in conjunction with the regular results.

Keyword advertising is growing as other types of web advertising are generally declining. It is believed there are at least several features that contribute to its success. First, sponsored results are piggybacked on regular results, so they are delivered in connection with a valuable, seemingly objective, service to the user. By contrast, search engines that are built primarily on sponsored results have not been as popular. Second, the precision of the targeting of the advertising means the user is more likely to find the advertisements useful, and consequently will perceive the advertisements as more of a part of the service than as an unwanted intrusion. Unlike banners and pop-up advertisements, which are routinely ignored or dismissed, users appear more likely to click through these sponsored results (i.e., keyword advertisements). Third, the targeting is based entirely on the current query, and not on demographic data developed over longer periods of time. This kind of targeting is timelier and more palatable to users with privacy concerns. Fourth, these advertisements reach users when they are searching, and therefore when they are more open to visiting new web sites.

Companies, such as Google of Mountain View, Calif. (which offers a search engine) and Overture of Pasadena, Calif. (which aggregates advertising for other search engines as well as offering its own search engine), use an auction mechanism combined with a pay-per-click (PPC) pricing strategy to sell advertising. This model is appealing in its simplicity. Advertisers bid in auctions for placement of their advertisements in connection with particular keywords or keyword combinations. The amount they bid (i.e., cost-per-click (CPC)) is the amount that they are willing to pay for a click-through to their link. For example, in one PPC pricing strategy, if company A bids $1.10 for “deck plans” then its advertisement will be placed above a company bidding $0.95. Only a selected number of bidders' advertisements will be shown. The simplicity of the model makes it easy for an advertiser to understand why an advertisement is shown, and what bid is necessary to have an advertisement shown. It also means that advertisers are charged only for positive responses.

Both Google and Overture offer tools to help users identify additional keywords based on an initial set of keywords. The Overture model supplies keywords that actually contain the keyword (e.g. for bicycle one can get road bicycle, Colonago bicycle, etc.). Google, on the other hand, performs some kind of topic selection, which they claim is based on billions of searches.

Both Google and Overture offer tools to help users manage their bids. Google uses click-through rate and PPC to estimate an expected rate of return which is then used to dynamically rank the advertisements. Overture uses the PPC pricing strategy to rank advertisements, but monitors the click-through rate for significantly under performing advertisements.

Because Google dynamically ranks the advertisements based on click-through and PPC, advertisers cannot control their exact advertisement position with a fixed PPC. To insure a top placement, the advertiser must be willing to pay a different price that is determined by their own click through rate as well as the competitors click-though rates and PPC. Overture uses a fixed price model, which insures fixed position for fixed price.

If a set of keywords that have not been selected by any of the advertisers is issued as a search term, Overture will attempt to find the best matching selected set of keywords and display its associated advertisements. For example, let's say a user searches on “engagement ring diamond solitaire.” However, there are no advertisers bidding on this search term. The expanded matching feature will then match (based on term, title and description) selected listings from advertisers that have bid on search terms like “solitaire engagement ring” and “solitaire diamond ring.”

A number of third parties provide services to Overture customers to identify and select keywords and track and rank bids. For example, BidRank, Dynamic Keyword Bid Maximizer, Epic Sky, GoToast, PPC BidTracker, PPC Pro, Send Traffic, and Sure Hits. There are a small number of pay-per-bid systems. For example, Kanoodle is a traditional pay-per-bid system like Overture. Other examples, include Sprinks and FindWhat.

Sprinks'ContentSprinks™ listings rely on context, as opposed to one-to-one matching with a keyword. The user chooses topics, rather than keywords. The web site says “Since context is more important than an exact match, you can put your offer for golf balls in front of customers who are researching and buying golf clubs, and your listing will still be approved, even though it's not an exact match.” This is a pay-per-bid model, like Overture, and has been used by About.com, IVillage.com and Forbes.com. KeywordSprinks™ is a traditional pay-per-bid model for keywords and phrases system.

FindWhat has a BidOptimizer that shows the bids of the top five positions so that a user can set their bid price for a keyword to be at a specific position. It does not continually adjust bids like E-Bay and Overture.

In addition, there is a system called Wordtracker for helping users to select keywords. The Wordtracker system at <www.wordtracker.com> provides a set of tools to help users to identify keywords for better placement of advertisements and web pages in search engines, both regular and pay-per-bid. Wordtracker provides related words with occurrence information, misspelled word suggestions based on the number of occurrences of the misspelled words, and tools for keeping track of possible keyword/key phrase candidates. The related words are more than variants. On the web site, an example of related keywords for “golf” includes pga, Ipga, golf courses, tiger woods, golf clubs, sports, jack nicklaus, and titleist, as well as phrases that include the term “golf,” such as golf clubs, golf courses, golf equipment, used golf clubs, golf tips, golf games, and vw.golf. Wordtracker displays the bid prices for a keyword on selected pay-per-bid search engines. It also displays the number of occurrences of search terms by search engine so the keywords can be tuned to each search engine.

In this description, the initial sale of keyword advertisement positions via auctions based on pay-per-click is referred to as the “primary” market for current rights in keyword advertising. Briefly, in one aspect of the primary market, advertisers bid in auctions for placement of their advertisements in connection with particular keywords or keyword combinations. The amount they bid is the amount that they are willing to pay for a click-through to their link. There are several variations of this primary market, one where the position of an advertisement is based on the product of bid and click through rate, and another “second price” variation where the amount paid is the bid of the next highest bidder. None of these variations currently include a secondary market for future rights in keyword advertisement positions. In the current form, the “winner” of an auction in the primary market receives immediate placement with the keywords—in other words, the “commodity,” which in this case is the placement, is immediately consumed.

The present exemplary embodiment contemplates operation of a secondary market for future rights to keyword advertisement placements which permits transfer of risks in the keyword advertising market, offers a number of business opportunities not available in the primary market, and overcomes the above-referenced problems and others.

### BRIEF DESCRIPTION

In accordance with one aspect of the present exemplary embodiment, shown is a method of trading a future right to a keyword advertisement placement associated with a search results list, wherein the search results list is generated in response to a search query. The method includes creating ownership of the future right to the keyword advertisement placement in an original keyword search engine. Next, the future right to the keyword advertisement placement originally owned by the original keyword search engine is made available for purchase in a keyword advertising market. Then the future right to the keyword advertisement placement originally owned by the original keyword search engine is traded to another participant in the keyword advertising market.

In accordance with a more limited aspect of the present exemplary embodiment, shown is a method of trading future rights to a plurality of keyword advertisement placements associated with a plurality of search results lists, wherein each search results list is generated in response to a search query. The method includes creating ownership of each of the future rights to the keyword advertisement placements in an original keyword search engine. Next, each of the future rights to the keyword advertisement placements originally owned by the original keyword search engine is made available for purchase in a keyword advertising market. Then a plurality of the future rights to the keyword advertisement placements originally owned by the original keyword search engine is traded to one or more participants in the keyword advertising market.

In accordance with a further aspect of the present exemplary embodiment, shown is a method of trading future rights to a plurality of keyword advertisement placements associated with a plurality of search results lists generated by a plurality of original keyword search engines, wherein each search results list is generated in response to a search query. The method includes creating ownership of each of the future rights to the keyword advertisement placements in a corresponding original keyword search engine of the plurality of keyword search engines. Next, each of the future rights to the keyword advertisement placements originally owned by the plurality of original keyword search engines are made available for purchase in a keyword advertising market. Then a plurality of the future rights to the keyword advertisement placements originally owned by the plurality of original keyword search engines are made to one or more participants in the keyword advertising market.

In accordance with still a further aspect of the present exemplary embodiment, shown is a method of trading a current right to a keyword advertisement placement associated with a search results list, wherein the search results list is generated in response to a search query. The method includes creating ownership of the current right to the keyword advertisement placement in an original keyword search engine. Next, the current right to the keyword advertisement placement originally owned by the original keyword search engine is made available for purchase in a keyword advertising market, wherein the future right to the keyword advertisement placement is made available for purchase at an established market price. Then the current right to the keyword advertisement placement originally owned by the original keyword search engine is traded to another participant in the keyword advertising market.

### BRIEF DESCRIPTION OF THE DRAWINGS

The exemplary embodiment may take form in various components and arrangements of components, and in various steps and arrangements of steps. The drawings are only for purposes of illustrating preferred embodiments and are not to be construed as limiting the exemplary embodiment.

FIG. 1 is a block diagram of an exemplary embodiment of a keyword searching environment facilitating transactions in a keyword advertising market, including a primary market for current rights to keyword advertisement placements and a secondary market for future rights to keyword advertisement placements;

FIG. 2 is a block diagram of another exemplary embodiment of a keyword searching environment facilitating transactions in the keyword advertising market;

FIG. 3 is a block diagram of yet another exemplary embodiment of a keyword searching environment facilitating transactions in the keyword advertising market;

FIG. 4 is a flow chart showing a variety of exemplary transactions available in the keyword advertising market, including the primary market and the secondary market.

### DETAILED DESCRIPTION

In various embodiments, this invention provides extensions to an existing keyword advertising market that offer stability to the market and improve overall risk management within the market. Through these various embodiments, the invention is flexible and adaptable to various models and strategies for buying, selling, trading, and managing keyword advertising. The stability and flexibility assist in solving the problem of creating an efficient market for keyword advertising and bidding for position/placement of keyword advertisements within a regular search results list or in association with such a list.

By incorporating at least some aspect of the invention, the keyword searching environment includes basic mechanisms to establish a secondary market for future rights to keyword advertisement placements in conjunction with a primary market for current rights to keyword advertisement placements. The secondary market may include, for example, options, futures contract, derivatives, private placements, and bundling tools, similar to those used in financial/commodities markets. The keyword searching environment with the secondary market thus includes more mechanisms for buying, selling, and trading, provides an opportunity for more efficiency in the keyword advertising market, and provides an opportunity to transfer market risks from entities desiring to reduce risk to entities willing to accept such risks.

The secondary market for keyword advertising uses several basic mechanisms to extend the keyword advertising market beyond auctions for current rights to keyword advertisement placements in the primary market. These mechanisms include: i) future rights in time, ii) transfer of future rights, iii) administrated return and auction of future rights, and iv) bundling.

With respect to future rights in time, a right to place an advertisement associated with particular keywords at some time in the future is auctioned or sold at an established market price by the keyword search engine provider (or by an aggregator or bundler of future rights, for example, for several search engines). Rights to keyword advertisement placements in the future can be sold or transferred by the future rights owner either in whole or in part.

The owner of future rights to keyword advertisement placements can return rights, in whole or in part, to the original keyword search engine provider (or an aggregator/bundler of current rights). Typically, the keyword search engine provider (or an aggregator/bundler) places the returned rights to keyword advertisement placements in an auction in the primary market. At least a portion of the proceeds from the auction are provided to the future rights owner that returned the rights in a consignment-like arrangement. If the future rights are returned at an appropriate time, the keyword search engine may auction the rights again as future rights in a similar arrangement with the future rights owner. The keyword search engine may re-sell the future rights in the primary or secondary market at established market prices. Other arrangements where the keyword search engine buys back the future rights and sells them by auction and/or at established market prices are also possible.

Future rights to keyword advertisement placements associated with groups of similar keywords can be bundled by a common owner into a single future right to placements, for example, on a particular topic using, for example, information retrieval technology. Owners of bundled future rights to keyword advertisement placements can un-bundle the rights by, for example, re-bundling the future rights into one or more smaller bundles of future rights, consuming some keywords, and returning other keywords for the administrated auction.

In the secondary market, the future right to keyword advertisement placements become a financial instrument with the usual possibilities for trading, selling short, and creating derivatives and options. The secondary market is useful, for example, in planning an advertising campaign. A large advertiser would like to plan a predictable amount of advertising for the end of a quarter. With an unpredictable primary market, keyword advertising cannot be budgeted months in advance—failure to win a keyword placement would likely require alternative media for advertising, with longer lead times to develop advertising and purchase placement. If an advertiser could purchase the right to place an advertisement in the future, or an option on such a right, the risks associated with planning keyword advertising is reduced.

The secondary market also creates an opportunity for third-party development of advertising strategies. Using a variety of means or insights, a third party may develop an effective strategy for advertising—such as, better keywords (i.e, higher click through, more conversions, or cheaper keywords) or better timing of advertisement placement. The secondary market allows a third party to purchase and bundle the future rights to relevant keywords and offer the principal advertiser a complete package or a subset of the bundled future rights.

The secondary market also allows investors or speculators, with no direct interest in placing keyword advertisements within search results list or in association with such lists, to speculate in the value of these placements. It is understood that any reference herein to investors or speculators also includes arbitragers and risk shifters and that any of these parties may automated trading systems to trade keyword advertisement placements in the secondary market. While such speculation can be abused, if the market is reasonably efficient, it has the benefit of moving risk to those most able and/or willing to manage the risk.

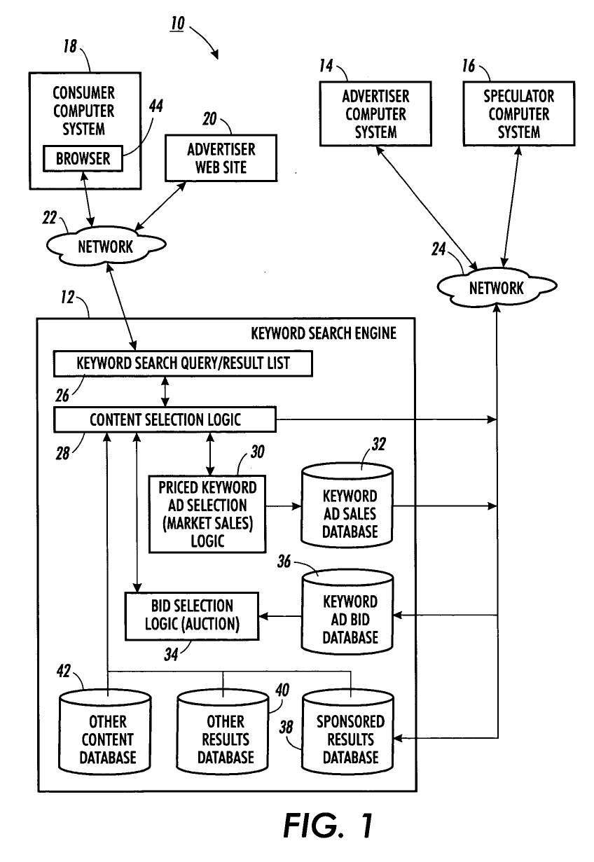

With reference to FIG. 1, an exemplary embodiment of a keyword searching environment 10 includes a keyword search engine 12, an advertiser computer system 14, a speculator computer system 16, a consumer computer system 18, and an advertiser web site 20. In this embodiment, the keyword search engine 12 sells placements for keyword advertisements associated with a search results list generated in response to a search query to advertisers via the advertiser computer system 14 and speculators via the speculator computer system 16. The speculator computer system 16 is any type of computer or automated trading system used by a speculator to participate in the secondary market. The search query is submitted by the consumer computer system 18 and, in response, the search results list and keyword advertisements corresponding to the keywords in the search query are provided to the consumer for display on the consumer computer system 18.

The placements for keyword advertisements sold by the keyword search engine 12 include current and future rights to keyword advertisement placements. Future rights may be sold in the primary market as current rights when the time for which the future right applies has matured. Current rights expire after the time for which the current right applies has past. The keyword search engine may sell the current and/or future rights to keyword advertisement placements by auction or at an established market price. Sales by auction are typically awarded to the highest bidder or a combination of the bids and click-through performance of the advertisement. Sales for an established market price are typically based on a first-to-offer or first-to-pay basis (i.e., first-come-first-served). The keyword search engine 12 may implement standing bids and a waiting list for sales at established market prices to facilitate transitions from one purchaser to another when a standing bid expires or is terminated.

The keyword search engine 12, consumer computer system 18, and advertiser web site 20 communicate via a first network 22, such as the Internet. However, any form of network suitable for data communication may be implemented. The advertiser computer system 14 and speculator computer system 16 communicates with the keyword search engine 12 via a second network 24. The second network 24 may also be implemented via the Internet or any other network suitable for data communication. As such, the first and second networks may be a common network, although, as shown, independent networks are envisioned.

The keyword search engine 12 includes a keyword search query/results list process 26, a content selection logic process 28, a priced keyword advertisement selection logic (market sales) process 30, a keyword advertisement sales database 32, a bid selection logic (auction) process 34, a keyword advertisement bid database 36, and a sponsored results (i.e., advertisement) database 38. The keyword search engine 12 may also include an other results (e.g., non-paid search results) database 40 and/or an other content (e.g., news, information, entertainment, etc.) database 42. Each of these processes and databases may be implemented by any suitable combination of hardware and/or software. One or more of the processes and databases may be combined in any suitable arrangement of hardware and/or software.

The consumer computer system 18 includes a browser process 44, such as Microsoft's Internet Explorer, Netscape, or another similar browser process. The browser process 44 provides users of the consumer computer system 16 with a user interface to submit keyword search queries to the keyword search engine 12 and to display the results generated by the keyword search engine 12 in response to such queries.

The keyword search query/results list process 26 receives a keyword search query from the browser process 44 and communicates the keywords to the content selection logic 28. The content selection logic 28, in turn, communicates the keywords to the priced keyword advertisement selection logic (market sales) process 30 and the bid selection logic (auction) process 34. The priced keyword advertisement selection logic (market sales) process 30 uses sales information for priced keyword advertisement placements stored in the keyword advertisement sales database 32 to determine which keyword advertisements will be included in priced keyword advertisement placements of th⁻ keyword search results list. If implemented, the priced keyword advertisement selection logic (market sales) process 30 includes mechanisms for standing bids and waiting lists with regard to keyword advertisement placements. The priced keyword advertisement selection logic (market sales) process 30 and keyword advertisement sales database 32 can also function as a mechanism for selling future rights to keyword advertisement placements as established market prices.

The bid selection logic (auction) process 34 uses bids for keyword advertisements stored in the keyword advertisement bid database 36 to determine which keyword advertisements will be included in auctioned keyword advertisement placements of the keyword search results list. This information is communicated to the content selection logic process 28. The bid selection logic (auction) process 34 and keyword advertisement bid database 36 can also function as a mechanism for auctioning future rights to keyword advertisement placements.

The content selection logic process 28 selects the appropriate keyword advertisements from the sponsored results database 38, as well as other appropriate content for the keyword search results list from the other results database 40 and the other content database 42 in response to the current keyword query. The content selection logic 28 communicates the appropriate content to the keyword search query/results list process 26. The keyword search query/results list process 26 compiles the keyword search results list. The results list for the current keyword query is communicated to the user at the consumer computer system 18 via the first network 22 and displayed to the user by the browser process 44.

The advertiser computer system 14 provides the advertiser with a means to interact with keyword computer engine 12 to purchase current and/or future rights to keyword advertisement placements via auction or through sales at established market prices. With respect to the auction, the advertiser computer system 14 provides the advertiser with a means to submit advertisements, keywords, and bids to the keyword search engine 12 and to associate the bids with certain keywords and certain advertisements. Similarly, with respect to the sales at established market prices, the advertiser computer system 14 provides the advertiser with a means to submit advertisements and keywords to the keyword search engine 12 and to purchase a current and/or future right to the corresponding keyword advertisement placement.

The advertiser computer system 14 can be any suitable computer device capable of communicating data to and from the keyword search engine 12. For example, the advertising computer system 14 can include a browser like the consumer computer system 18 if the keyword search engine 12 provides a web-based interface to the second network 24. Otherwise, the advertiser computer system 14 may use any suitable user interface compatible with the keyword search engine 12 interface to the second network 24.

The speculator computer system 16 provides the speculator with a means to interact with keyword computer engine 12 to purchase future rights to keyword advertisement placements via auction or through sales at established market prices. With respect to the auction, the speculator computer system 14 provides the advertiser with a means to submit advertisements, keywords, and bids to the keyword search engine 12 and to associate the bids with certain keywords and certain advertisements. Similarly, with respect to the sales at established market prices, the speculator computer system 14 provides the speculator with a means to submit advertisements and keywords to the keyword search engine 12 and to purchase a future right to the corresponding keyword advertisement placement.

The speculator computer system 16 can also be any suitable computer device capable of communicating data to and from the keyword search engine 12. Like the advertising computer system 14, the speculator computer system 16 can include a browser like the consumer computer system 18 if the keyword search engine 12 provides a web-based interface to the second network 24. Otherwise, the speculator computer system 14 may use any suitable user interface compatible with the keyword search engine 12 interface to the second network 24.

Of course, the keyword searching environment 10 can be expanded to include a plurality of advertiser computer systems 14 and/or a plurality of speculator computer systems 16 in communication with the second network 24. Likewise, the keyword searching environment 10 can be expanded to include a plurality of keyword search engines 12 in communication with the first and second networks 22, 24. Any number of the advertiser computer systems 14 and/or speculator computer systems 16 may be in communication with any one or more of the plurality of keyword search engines 12. Communications between any combination of keyword search engines 12, advertiser computer systems 14, and speculator computer systems 16 can be via the second network 24 or any combination of independent networks.

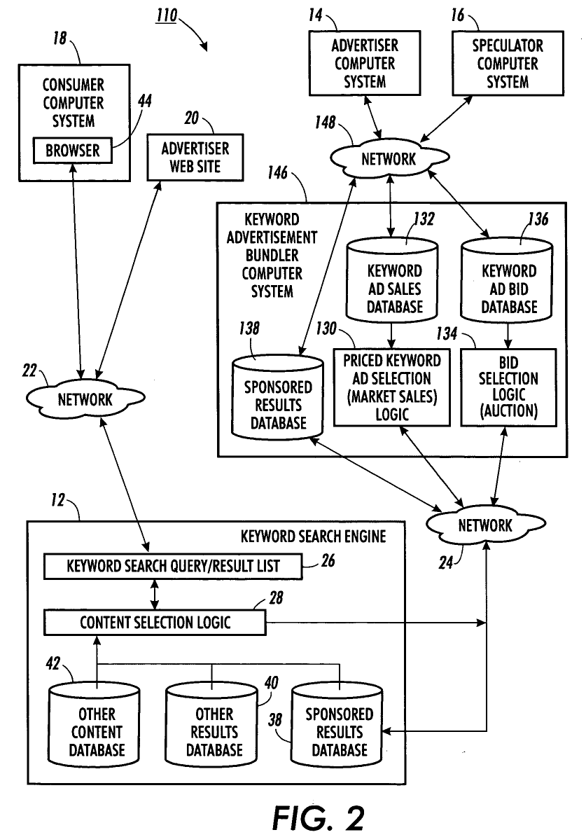

With reference to FIG. 2, another exemplary embodiment of a keyword searching environment 110 includes the keyword search engine 12, the advertiser computer system 14, the speculator computer system 16, the consumer computer system 18, the advertiser web site 20, the first network 22, the second network 24, a keyword advertisement bundler computer system 146, and a third network 148. In this embodiment, a keyword advertisement bundler sells placements for keyword advertisements to advertisers and speculators for the keyword search engine 12 via the keyword advertisement bundler computer system 146. Otherwise, the keyword searching environment generally operates as described above in reference to FIG. 1.

Using the keyword advertisement bundler to sell rights to keyword advertisement placements is an option available to the keyword search engine 12 which relieves the keyword search engine 12 from evaluating sales and/or bids for at least a portion of keywords handled by the keyword advertisement bundler. The keyword advertisement bundler may bundle the rights to keyword advertisement placements by groups of keywords and/or by time. The keyword advertisement bundler may serve multiple search engines and may bundle the rights to keyword advertisement placements on multiple search engines. The bundled rights to keyword advertisement placements may be sold via auction or at established market prices.

The keyword advertisement bundler provides its service to the keyword search engine 12 through a keyword advertisement bundler computer system 146. The keyword advertisement bundler computer system 146 is in communication with the keyword search engine 12 via the second network 24. The keyword advertisement bundler computer system 146 may include any suitable type of computing device, including a network of computers associated with the keyword advertisement bundler. The keyword advertisement bundler computer system 146 includes a priced keyword advertisement selection logic (market price) process 130, a keyword advertisement sales database 132, a bid selection logic (auction) process 134, a keyword advertisement bid database 136, and a sponsored results database 138 for selling rights to keyword advertisement placements. These processes generally operate as described above for the like-named and similarly-numbered processes within the keyword search engine of FIG. 1.

The advertiser computer system 14 and speculator computer system 16 communicate with the keyword advertisement bundler computer system 146 via a third network 148. The third network 148 may be implemented via the Internet or any other network suitable for data communication. As such, the second and third networks may be a common network, although, as shown, independent networks are envisioned.

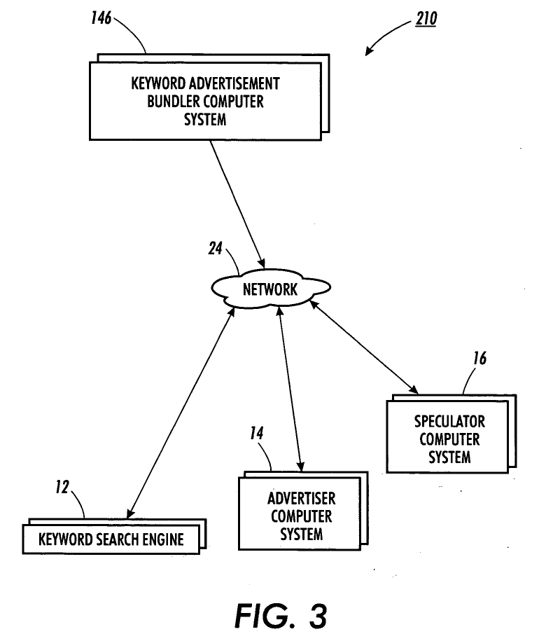

With reference to FIG. 3, yet another exemplary embodiment of a keyword searching environment 210 includes a plurality of keyword search engines 12, a plurality of advertiser computer systems 14, a plurality of speculator computer systems 146, and a plurality of keyword advertisement bundler computer systems 146. Each of these components may communicate with any other component using the second network 24. As described above, the second network 24 may also be implemented via the Internet or any other network suitable for data communication. Communications between any combination of keyword search engines 12, advertiser computer systems 14, speculator computer systems 16, and speculator computer systems 146 can be via the second network 24 or any combination of independent networks.

This embodiment of a keyword searching environment 210 is a hybrid of the keyword searching environment 10, 110 described above in reference to FIGS. 1 and 2 with the third network 148 of FIG. 2 merged with the second network 24. The keyword searching environment 210 and the keyword search engines 12, advertiser computer systems 14, speculator computer systems 146, and keyword advertisement bundler computer systems 146 generally operate as described above in reference to FIGS. 1 and 2.

The current and future rights to keyword advertisement placements originate with each of the keyword search engines 12. Each keyword search engine 12 may choose to sell its original rights to keyword advertisement placements in the primary and second markets or may elect to sell its original current and/or future rights through a keyword advertisement bundler via the bundler's keyword advertisement bundler computer system 146. A given keyword advertisement bundler may sell the original and/or future rights for multiple keyword search engines 12. The keyword search engines 12 and keyword advertisement bundlers can sell current rights by auction or at established market prices to advertisers via the advertisement computer systems 14. This is described above as the primary market.

The keyword search engines 12 can sell future rights by auction or at established market prices to advertisers, keyword advertisement bundlers, and/or speculators via the advertisement computer systems 14, keyword advertisement bundler computer systems 146, and speculator computer systems 16. This is described above as the secondary market. Advertisers, keyword advertisement bundlers, or speculators can bundle future rights to keyword advertisement placements in any manner. For example, future rights can be bundled with respect to time, keywords, and/or originating search engines. Advertisers can consume some future rights from a bundle of rights when they mature and re-bundle the remaining future rights for sale in the primary or secondary market.

Keyword advertisement bundlers and speculators can, for example, split bundled future rights and re-sell them in the primary or secondary market. Keyword advertisement bundlers can, for example, bundle future rights with respect to time, keywords, and/or originating search engines and re-sell them in the primary or secondary market.

Typically, sales of future rights by advertisers, keyword advertisement bundlers, and speculators in the primary market are returned to the original keyword search engine 12 for selling through its primary market mechanisms (including sales through keyword advertisement bundlers). However, sales of future rights by advertisers, keyword advertisement bundlers, and speculators in the secondary market can be to anyone participating in the secondary market, including keyword search engines. Hence, keyword search engines 12 can buy back future rights and can even invest in future rights to keyword advertisement placements on other search engines.

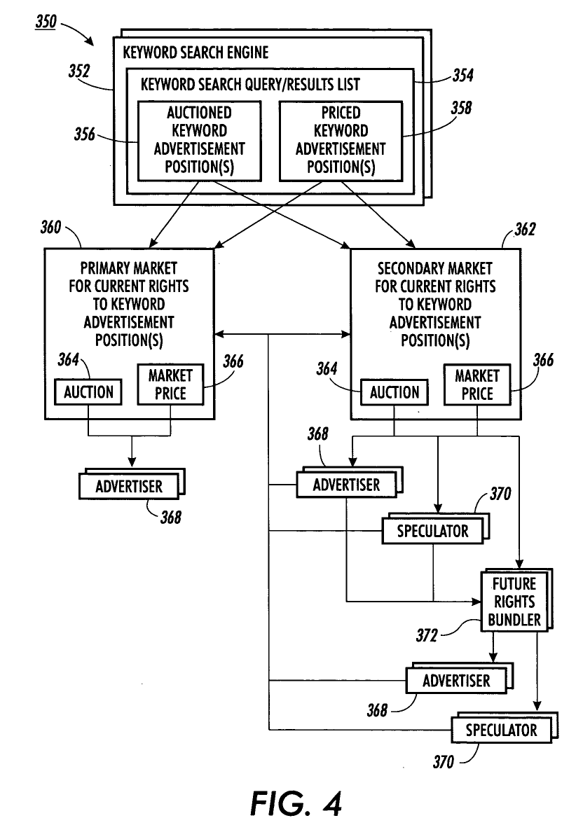

With reference to FIG. 4, exemplary transactions between the various participants in the keyword advertising market 350 are depicted. The keyword advertising market 350 begins with a plurality of keyword search engines 352. Each keyword search engine 352 identifies keyword advertisement placements associated with or within keyword search query/results lists 354. Any keyword search query/results list 354 may include one or more auctioned keyword advertisement placements 356 and one or more priced keyword advertisement placements 358. Each keyword search engine 352 initially sells its current rights to keyword advertisement placements in the primary market 360 via auction 364 or at an established market price 366. This primary market transaction can be handled by primary market mechanisms within the keyword search engine 352 or through a keyword advertisement bundler serving one or more keyword search engines. Similarly, each keyword search engine 352 initially sells its future rights to keyword advertisement placements in the secondary market 362 via auction 364 or at an established market price 366. This secondary market transaction can be handled by secondary market mechanisms within the keyword search engine 352 or through a keyword advertisement bundler serving one or more keyword search engines.

The initial transactions in the primary market are either between the original keyword search engine 352 and advertisers 368 or through a keyword advertisement bundler to advertisers 368. For auctioned keyword advertisement placements, the winning advertisers are granted current rights to advertisement placements for corresponding keywords. For priced keyword advertisement placements, the purchasing advertisers are granted current rights to advertisement placements for corresponding keywords. Current rights to keyword advertisement placements are consumed by the advertisers 368 granted such rights.

The initial transactions in the secondary market are either between the original keyword search engine 352 and advertisers 368, speculators 370, and/or future rights bundlers 372 or through a keyword advertisement bundler to advertisers 368 speculators 370, and/or future rights bundlers 372. Due to the nature of future rights, a variety of additional types of transactions are available between the participants of the secondary market.

For example, an advertiser 368 owning future rights can sell all or part of the future rights in the secondary market to the originating keyword search engine 352 or a future rights bundler 372, consume all or part of the rights as they mature into current rights, and/or sell all or part of the future rights to the originating keyword search engine 352. Similarly, a speculator 370 owning future rights can sell all or part of the future rights in the secondary market to the originating keyword search engine 352 or a future rights bundler 372 and/or sell all or part of the future rights to the originating keyword search engine 352. Likewise, a future rights bundler 372 owning future rights can sell all or part of the future rights in the secondary market to the originating keyword search engine 352 or another future rights bundler 372 and/or sell all or part of the future rights to the originating keyword search engine 352. However, the future rights bundler 372 owning future rights can also bundle future rights with respect to time, keywords, and across multiple search engines. The future rights bundler 372 can also sell all or part of the future rights in the secondary market to the advertisers 368 or speculators 370. Other types of transactions between any of the participants in the secondary market are also envisioned.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of trading a future right to a keyword advertisement placement associated with a search results list, wherein the search results list is generated in response to a search query, the method including the steps:
a) creating ownership of the future right to the keyword advertisement placement in an original keyword search engine;
b) making the future right to the keyword advertisement placement originally owned by the original keyword search engine available for purchase in a keyword advertising market; and
c) trading the future right to the keyword advertisement placement originally owned by the original keyword search engine to another participant in the keyword advertising market.

2. The method as set forth in claim 1 wherein the future right to the keyword advertisement placement is made available for purchase by the original keyword search engine.

3. The method as set forth in claim 2 wherein the future right to the keyword advertisement placement is made available for purchase through a keyword advertisement bundler.

4. The method as set forth in claim 1 wherein the future right to the keyword advertisement placement is made available for purchase via an auction.

5. The method as set forth in claim 4 wherein the future right to the keyword advertisement placement is traded to the another participant based at least in part on a bid for the future right by the another participant.

6. The method as set forth in claim 1 wherein the future right to the keyword advertisement placement is made available for purchase at an established market price.

7. The method as set forth in claim 6 wherein the future right to the keyword advertisement placement is traded to the another participant based at least in part on the another participant offering at least the established market price for the future right while the future right was available for purchase.

8. The method as set forth in claim 1 wherein participants in the keyword advertising market include keyword search engines, advertisers, speculators, and future rights bundlers.

9. The method as set forth in claim 1 wherein the another participant to whom the future right to the keyword advertisement placement is traded includes at least one of an advertiser, a speculator, and a future rights bundler.

10. The method as set forth in claim 1 wherein the future right is at least defined to extend from a start time to an end time.

11. The method as set forth in claim 10 wherein the another participant to whom the future right to the keyword advertisement placement is traded includes at least one future rights bundler.

12. The method as set forth in claim 11, further including:
d) splitting the future right owned by the at least one future rights bundler into at least two split future rights to keyword advertisement placements;
e) repeating steps b) and c) wherein in step b) the at least two split future rights are made available for purchase and in step c) the at least two split future rights are traded to one or more participants in the keyword advertising market.

13. The method as set forth in claim 12 wherein the one or more participants to whom the at least two split future rights are traded includes at least one of an advertiser, a speculator, a future rights bundler, the original keyword search engine, or a second keyword search engine.

14. The method as set forth in claim 12 wherein the future right is split based at least in part on dividing the time associated with the start time to the end time into smaller increments of time.

15. The method as set forth in claim 1, further including:
d) repeating steps b) and c) wherein in step b) the future right is again made available for purchase and in step c) the future right is traded to a second participant in the keyword advertising market.

16. The method as set forth in claim 16 wherein the second participant to whom the future right to the keyword advertisement placement is traded includes at least one of an advertiser, a speculator, a future rights bundler, the original keyword search engine, or a second keyword search engine.

17. The method as set forth in claim 1, further including:
d) making a current right to the keyword advertisement placement associated with the future right available for purchase in the keyword advertising market; and
e) trading the current right to the keyword advertisement placement to a second participant in the keyword advertising market.

18. The method as set forth in claim 17 wherein the current right to the keyword advertisement placement is made available for purchase through the original keyword search engine or a keyword advertisement bundler associated with the original keyword search engine.

19. The method as set forth in claim 17 wherein the current right to the keyword advertisement placement is made available for purchase via an auction.

20. The method as set forth in claim 17 wherein the current right to the keyword advertisement placement is made available for purchase at an established market price.

21. The method as set forth in claim 17 wherein the second participant to whom the current right to the keyword advertisement placement is traded includes at least one advertiser.

22. The method as set forth in claim 1 wherein the future right includes at least one of an option, a futures contract, a derivative, and a private placement.

23. A method of trading future rights to a plurality of keyword advertisement placements associated with a plurality of search results lists, wherein each search results list is generated in response to a search query, the method including the steps:
a) creating ownership of each of the future rights to the keyword advertisement placements in an original keyword search engine;
b) making each of the future rights to the keyword advertisement placements originally owned by the original keyword search engine available for purchase in a keyword advertising market; and
c) trading a plurality of the future rights to the keyword advertisement placements originally owned by the original keyword search engine to one or more participants in the keyword advertising market.

24. The method as set forth in claim 23 wherein the one or more participants to whom the plurality of future rights to the keyword advertisement placements are traded includes at least one first future rights bundler to whom at least two future rights to keyword advertisement placements are traded.

25. The method as set forth in claim 24, further including:
d) bundling the at least two future rights owned by the at least one first future rights bundler to form a bundled future right to keyword advertisement placements;
e) repeating steps b) and c) wherein in step b) the bundled future right is made available for purchase and in step c) the bundled future right is traded to at least one participant in the keyword advertising market.

26. The method as set forth in claim 25 wherein the at least one participant to whom the bundled future right is traded includes at least one second future rights bundler.

27. The method as set forth in claim 26, further including:
d) splitting the bundled future right owned by the at least one second future rights bundler into at least two split future rights to keyword advertisement placements;
e) repeating steps b) and c) wherein in step b) the at least two split future rights are made available for purchase and in step c) the at least two split future rights are traded to one or more participants in the keyword advertising market.

28. The method as set forth in claim 27 wherein the one or more participants to whom the at least two split future rights are traded includes at least one of an advertiser, a speculator, a future rights bundler, the original keyword search engine, or a second keyword search engine.

29. The method as set forth in claim 27 wherein the bundled future right is split based at least in part on dividing a start time to an end time associated with the bundled future right into smaller increments of time.

30. The method as set forth in claim 27 wherein the bundled future right is split based at least in part on dividing multiple keyword advertisement placements associated with the bundled future right into smaller increments of keyword advertisement placements.

31. The method as set forth in claim 27 wherein the bundled future right is split based at least in part on dividing multiple search queries associated with the bundled future right into smaller increments of search queries.

32. The method as set forth in claim 23, further including:
d) repeating steps b) and c) wherein in step b) at least one of the future rights is again made available for purchase and in step c) the at least one of the future rights is traded to at least one participant in the keyword advertising market.

33. The method as set forth in claim 32 wherein the at least one participant to whom the at least one of the future rights to the keyword advertisement placements is traded includes at least one of an advertiser, a speculator, a future rights bundler, the original keyword search engine, or a second keyword search engine.

34. A method of trading future rights to a plurality of keyword advertisement placements associated with a plurality of search results lists generated by a plurality of original keyword search engines, wherein each search results list is generated in response to a search query, the method including the steps:
a) creating ownership of each of the future rights to the keyword advertisement placements in a corresponding original keyword search engine of the plurality of keyword search engines;
b) making each of the future rights to the keyword advertisement placements originally owned by the plurality of original keyword search engines available for purchase in a keyword advertising market; and
c) trading a plurality of the future rights to the keyword advertisement placements originally owned by the plurality of original keyword search engines to one or more participants in the keyword advertising market.

35. The method as set forth in claim 34 wherein the one or more participants to whom the plurality of future rights to the keyword advertisement placements are traded includes at least one first future rights bundler to whom at least two future rights to keyword advertisement placements are traded, at least a first future right of the at least two future rights being originally owned by a first original keyword search engine and at least a second future right of the at least two future rights being originally owned by a second original keyword search engine.

36. The method as set forth in claim 35, further including:
d) bundling the at least two future rights owned by the at least one first future rights bundler to form a bundled future right to keyword advertisement placements;
e) repeating steps b) and c) wherein in step b) the bundled future right is made available for purchase and in step c) the bundled future right is traded to at least one participant in the keyword advertising market.

37. The method as set forth in claim 36 wherein the at least one participant to whom the bundled future right is traded includes at least one second future rights bundler.

38. The method as set forth in claim 37, further including:
d) splitting the bundled future right owned by the at least one second future rights bundler into at least two split future rights to keyword advertisement placements;
e) repeating steps b) and c) wherein in step b) the at least two split future rights are made available for purchase and in step c) the at least two split future rights are traded to one or more participants in the keyword advertising market.

39. The method as set forth in claim 38 wherein the one or more participants to whom the at least two split future rights are traded includes at least one of an advertiser, a speculator, a future rights bundler, or one of the original keyword search engines.

40. The method as set forth in claim 38 wherein the bundled future right is split based at least in part on dividing a start time to an end time associated with the bundled future right into smaller increments of time.

41. The method as set forth in claim 38 wherein the bundled future right is split based at least in part on dividing multiple keyword advertisement placements associated with the bundled future right into smaller increments of keyword advertisement positions.

42. The method as set forth in claim 38 wherein the bundled future right is split based at least in part on dividing multiple search queries associated with the bundled future right into smaller increments of search queries.

43. The method as set forth in claim 38 wherein the bundled future right is split based at least in part on dividing multiple original keyword search engines associated with the bundled future right into smaller increments of original keyword search engines.

44. The method as set forth in claim 34, further including:
d) repeating steps b) and c) wherein in step b) at least one of the future rights is again made available for purchase and in step c) the at least one of the future rights is traded to at least one participant in the keyword advertising market.

45. The method as set forth in claim 43 wherein the at least one participant to whom the at least one of the future rights to the keyword advertisement placements is traded includes at least one of an advertiser, a speculator, a future rights bundler, or one of the original keyword search engines.

46. A method of trading a current right to a keyword advertisement placement associated with a search results list, wherein the search results list is generated in response to a search query, the method including the steps:
a) creating ownership of the current right to the keyword advertisement placement in an original keyword search engine;
b) making the current right to the keyword advertisement placement originally owned by the original keyword search engine available for purchase in a keyword advertising market, wherein the future right to the keyword advertisement placement is made available for purchase at an established market price; and
c) trading the current right to the keyword advertisement placement originally owned by the original keyword search engine to another participant in the keyword advertising market.

47. The method as set forth in claim 46 wherein the current right to the keyword advertisement placement is made available for purchase by the original keyword search engine.

48. The method as set forth in claim 47 wherein the current right to the keyword advertisement placement is made available for purchase through a keyword advertisement bundler.

49. The method as set forth in claim 47 wherein the current right to the keyword advertisement placement is traded to the another participant based at least in part on the another participant offering at least the established market price for the current right while the current right was available for purchase.

50. The method as set forth in claim 1 wherein participants in the keyword advertising market include advertisers.
